(19) United States
(12) Patent Application Publication
(10) Pub. No.: US 2024/0247682 A1
(43) Pub. Date: Jul. 25, 2024

(54) MOUNTING ASSEMBLY FOR TRANSPORTATION AND/OR HANDLING OF A VEHICLE PART

(71) Applicant: Honda Motor Co., Ltd., Tokyo (JP)

(72) Inventors: Travis M. REEL, Ostrander, OH (US); Jesus A. DIAZ GONZALEZ, Dublin, OH (US); Ronald Cole BROSIE, Marysville, OH (US)

(21) Appl. No.: 18/099,488

(22) Filed: Jan. 20, 2023

(51) Int. Cl. F16B 45/00; F16B 43/00

(52) U.S. Cl. CPC F16B 45/002; F16B 43/00

(57) ABSTRACT

A mounting assembly for transportation and/or handling of a vehicle part includes an anchor plate, a harness bracket, a fastener and a tooth washer. The anchor plate includes a mounting aperture. The harness bracket is positioned atop the anchor plate. The harness bracket includes a through hole aligned with the mounting aperture and at least two raised features extended from an upper surface of the harness bracket and located adjacent the through hole. The raised features are integral with the harness bracket. The fastener extended through the through hole and the mounting aperture is in direct contact with the raised features. The tooth washer is fitted onto the fastener beneath the anchor plate to maintain positioning of the harness bracket atop the anchor plate.

### BACKGROUND

Mounting assemblies are typically provided for transportation and/or handing of a vehicle part. For example, for a vehicle seat, the mounting assemblies can be connected to a seat belt webbing and/or a seat belt harness and arranged to maintain positioning relative to the vehicle seat for later installation. However, if the arrangement of the mounting assembly is not proper, components of the mounting assembly can become misaligned making the later installation of the vehicle seat cumbersome and time-consuming.

### BRIEF DESCRIPTION

According to one aspect, a mounting assembly for transportation and/or handling of a vehicle part includes an anchor plate, a harness bracket, a fastener and a tooth washer. The anchor plate includes a mounting aperture. The harness bracket is positioned atop the anchor plate. The harness bracket includes a through hole aligned with the mounting aperture and at least two raised features extended from an upper surface of the harness bracket and located adjacent the through hole. The raised features are integral with the harness bracket. The fastener extended through the through hole and the mounting aperture is in direct contact with the raised features. The tooth washer is fitted onto the fastener beneath the anchor plate to maintain positioning of the harness bracket atop the anchor plate.

According to another aspect, a harness bracket for a mounting assembly for transportation and/or handling of a vehicle part is provided. The mounting assembly includes an anchor plate secured to the vehicle part, the harness bracket positioned atop the anchor plate, a fastener positioned atop the harness bracket and extended through the anchor plate and the harness bracket, and a tooth washer fitted onto the fastener beneath the anchor plate. The harness bracket includes a through hole for receipt of the fastener, and at least three standoff protrusions integrally formed on an upper surface of the harness bracket and located about the through hole for spacing the fastener from the upper surface.

According to another aspect, a method of assembling a mounting arrangement for transportation and/or handling of an associated vehicle part is provided. The method includes providing an anchor plate for connection to the associated vehicle part, the anchor plate including a mounting aperture; providing a harness bracket including a through hole, and positioning the harness bracket atop the anchor plate relative to a height direction of the mounting arrangement with the through hole aligned with the mounting aperture, wherein the harness bracket further includes at least three standoff projections extended from an upper surface of the harness bracket and located adjacent the through hole; providing a fastener, and extending the fastener through the through hole and the mounting aperture, wherein the fastener is in direct contact with the at least three standoff projections; and providing a tooth washer, and press fitting the tooth washer onto the fastener extended beneath the anchor plate to maintain positioning of the harness bracket atop the anchor plate.

### BRIEF DESCRIPTION OF THE DRAWINGS

FIG. 1 is a perspective view of a known mounting assembly for transportation and/or handing of a vehicle part, the mounting assembly generally including an anchor plate, a harness bracket, a fastener, a split washer and a tooth washer.

FIG. 2 is a perspective view of the known mounting assembly showing the split washer in a free, uncompressed state.

FIG. 3 is a cross-sectional view of the known mounting assembly with the spilt washer in a compressed state and the tooth washer pressed tightly against an underside of the anchor plate.

FIG. 4 is a cross-sectional view of the known mounting assembly with the tooth washer spaced from the underside of the anchor plate.

FIG. 5 is a perspective view the known mounting assembly with the harness bracket out of position relative to the anchor plate due to the location of the tooth washer of FIG. 4.

FIG. 6 is a perspective view of a mounting assembly for transportation and/or handing of a vehicle part according to the present disclosure.

FIG. 7 is an enlarged perspective view of FIG. 6.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or feature's relationship to another element(s) and/or feature(s) as, for example, illustrated in the figures. Moreover, any term of degree used herein, such as “substantially” and “approximately”, means a reasonable amount of deviation of the modified word is contemplated such that the end result is not significantly changed.

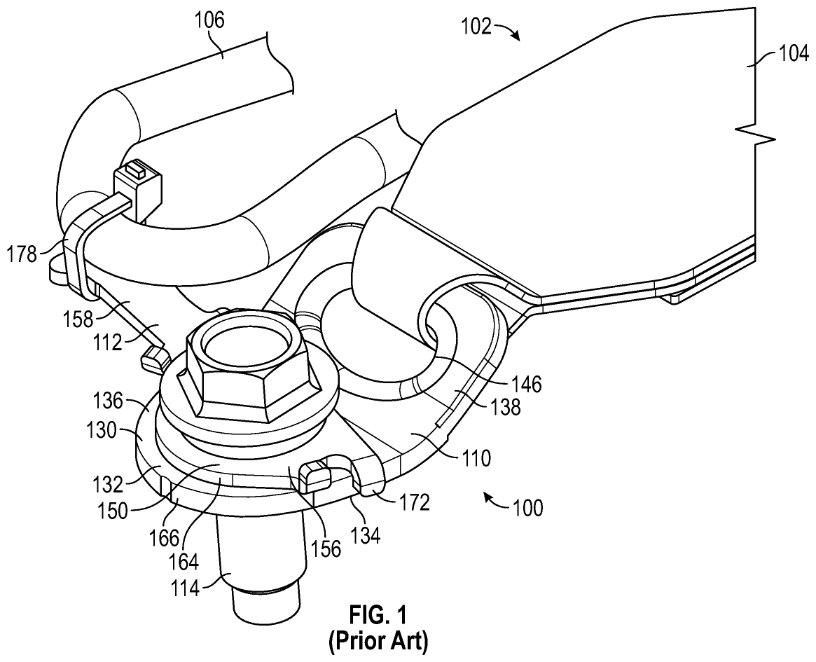

Referring now to the drawings, wherein like numerals refer to like parts throughout the several views, FIGS. 1-3 illustrate a known mounting assembly 100 for transportation and/or handing of a vehicle part 102. For example, the vehicle part 102 can be a vehicle seat, and the mounting assembly 100 can be connected to a seat belt webbing 104 and/or a seat belt harness 106 and arranged to maintain positioning relative to the vehicle seat for later installation. As depicted, the known mounting assembly 100 generally comprises an anchor plate 110, a harness bracket 112 positioned atop the anchor plate 110, a fastener 114, for example a bolt, extended through the anchor plate 110 and the harness bracket 112, a split washer 116 provided between the harness bracket 112 and the fastener 114, and a tooth washer 118 fitted on the fastener 114 beneath the anchor plate 110.

The anchor plate 110 includes a body 130 having an upper surface 132 and a lower surface 134 relative to a height direction of the mounting assembly 100. The body 130 further includes a first body portion 136 and a second body portion 138, which can extend obliquely from the first body portion 136. The first body portion 136 includes a mounting aperture 144 for the fastener 114. The second body portion 138 is adapted for connection to the vehicle part 102, for example, to the webbing 104 via an opening 146 in the second body portion 138.

The harness bracket 112 positioned atop the anchor plate 110 includes a body 150 having an upper surface 152 and a lower surface 154 relative to the height direction of the mounting assembly 100. The body 150 further includes a first body portion 156 and a second body portion 158. The first body portion 156 includes a through hole 160 for the fastener 114. The first body portion 156 is adapted to be seated atop the first body portion 136 of the anchor plate 110, and when properly seated the through hole 160 is aligned with the mounting aperture 144. Further, to prevent inadvertent moving of the harness bracket 112 relative to the anchor plate 110, an outer peripheral edge portion 164 of the first body portion 156 is offset inwardly of an outer peripheral edge portion 166 of the first body portion 136, and the body 150 includes at least one alignment tab 172 that engages the outer peripheral edge portion 166 of the anchor plate 110. The second body portion 158 extends in a substantially arm-like manner from the first body portion 156 and, with the first body portion 156 properly seated on the anchor plate 110 the second body portion 158 extends away from the connection of the anchor plate 110 to the webbing 104 for connection to the seat belt harness 106 via, for example, a cable tie 178.

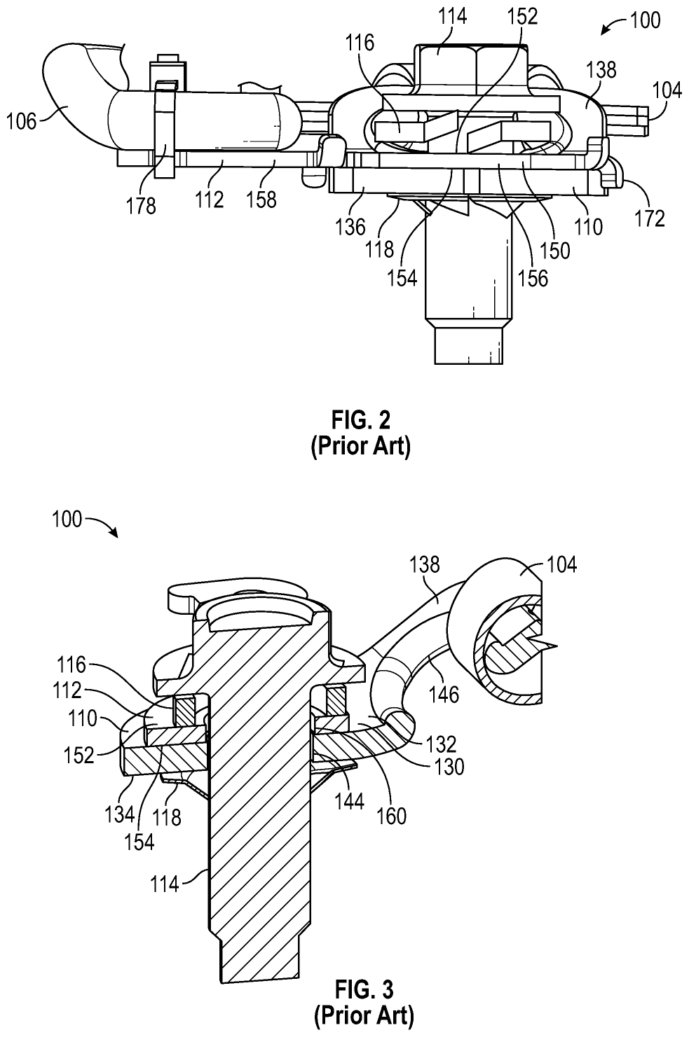

As depicted in FIGS. 2 and 3, the split washer 116 is located between the harness bracket 112 and the fastener 114. As is well known, the split washer 116 has an opening where one side gradually rises above the other side that compresses while simultaneously pushing against the harness bracket 112 and the fastener 114. Therefore, when properly arranged the split washer 116 can protect against vibrations and distribute an applied load of the fastener 114 more evenly to the harness bracket 112 to prevent tilting of the harness bracket relative to the anchor plate 110. The depicted tooth washer 118 features teeth-like-serrations designed to prevent bolted joints from loosening using friction. The tooth washer 118 is fitted on the fastener 114 and pressed against the underside or lower surface 134 of the anchor plate 110.

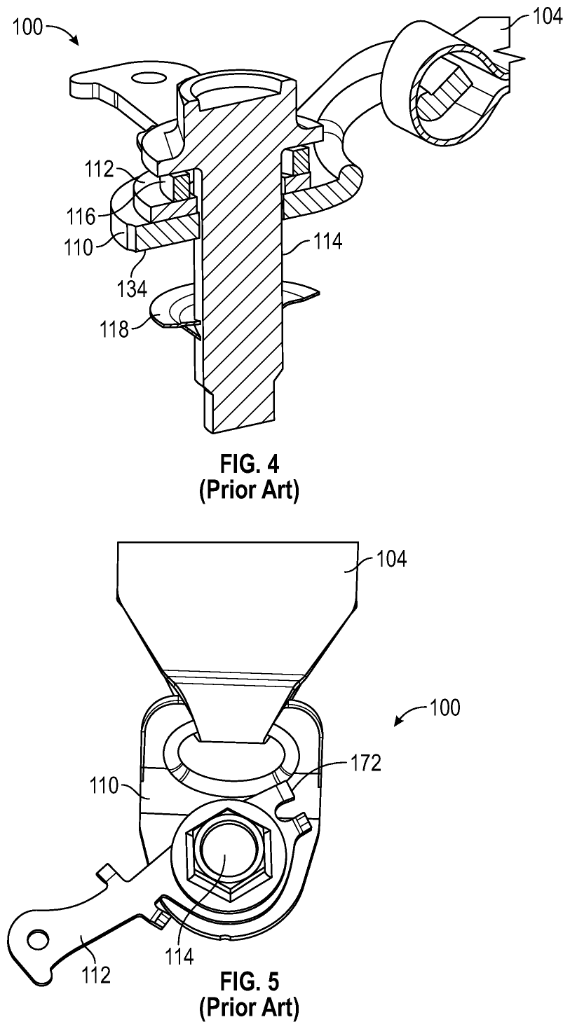

When properly installed, the tooth washer 118 prevents loosening of the fastener 114 and, in turn, movement of the harness bracket 112, during transportation and/or handling of the vehicle part. However, one problem with the known mounting assembly 100 is that the split washer 116 in the free, uncompressed state (see FIG. 2) can make it difficult to set the position of the tooth washer 118 where both harness bracket position can be maintained and the fastener 114 is free to rotate, which is desired for later installation of the vehicle part. If the tooth washer 118 is pushed too tightly against the lower surface 134 of the anchor plate 110 to maintain harness bracket position the fastener 114 can be prevented from rotating freely. Another problem with the known mounting assembly 100 is where the tooth washer 118 is too low on the fastener 114, as depicted in FIG. 4. In this instance, the harness bracket 112 can freely rotate relative to the anchor plate 110 (see FIG. 5) and can be subsequently damaged during vehicle part 102 installation.

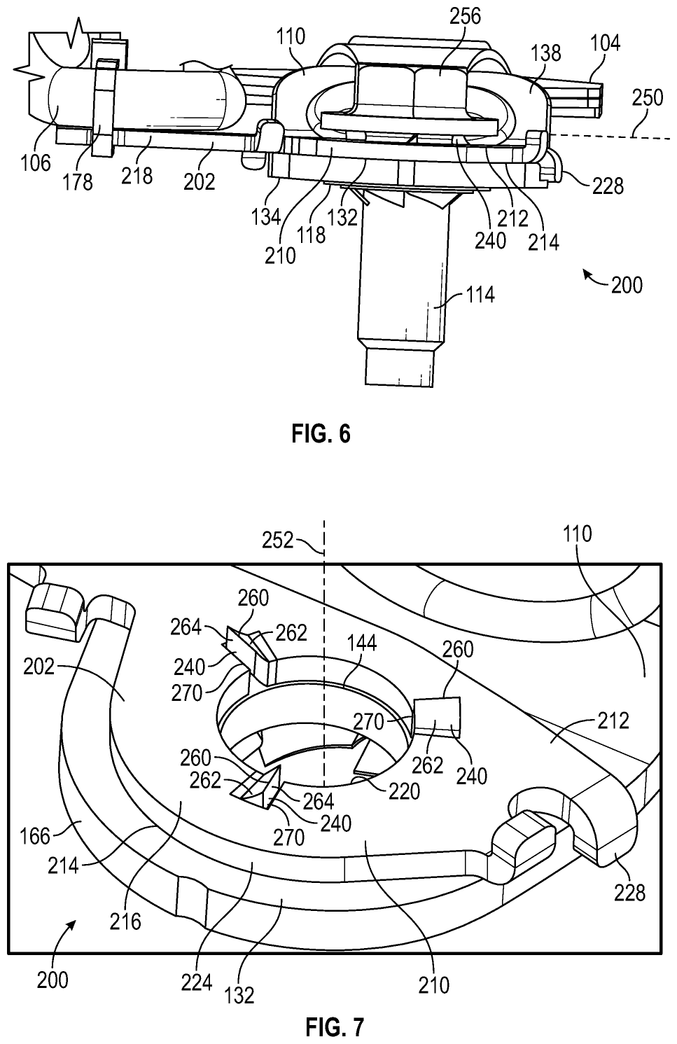

To address the above noted problems of the known mounting assembly 100, the mounting assembly 200 according to the present disclosure comprises an improved harness bracket 202 configured in a manner that allows for removal of the split washer 116. With reference to FIGS. 6 and 7, the exemplary mounting assembly 200 comprises the anchor plate 110, the harness bracket 202 positioned atop the anchor plate relative to a height direction of the mounting assembly 200, the fastener 114, extended through the anchor plate 110 and the harness bracket 202, and the tooth washer 118 fitted on the fastener beneath the anchor plate 110.

The exemplary harness bracket 202, which can have an overall shape similar to the known harness bracket 112, includes a body 210 having an upper surface 212 and a lower surface 214 relative to the height direction of the mounting assembly 200. The body 210 further includes a first body portion 216 and a second body portion 218. The first body portion 216 includes a through hole 220 for the fastener 114. The first body portion 216 is adapted to be seated atop the first body portion 136 of the anchor plate 110, and when properly seated the lower surface 214 is substantially flush with the upper surface 132 and the through hole 220 is aligned with the mounting aperture 144. Similar to the harness bracket 112, to prevent inadvertent moving of the harness bracket 202 relative to the anchor plate 110, an outer peripheral edge portion 224 of the first body portion 216 is offset inwardly of the outer peripheral edge portion 166 of the first body portion 136 of the anchor plate 110, and the body 210 includes at least one alignment tab 228 that, in an installed position of the harness bracket, engages the outer peripheral edge portion 166 of the anchor plate 110. The second body portion 218 extends from the first body portion 156 for connection to the seat belt harness 106 via, for example, the cable tie 178.

In lieu of the split washer 116 with the known mounting assembly 100 and the problems associated therewith, the exemplary harness bracket 202 of the mounting assembly 200 further includes at least two raised features 240 that are adapted to perform in a manner similar to the split washer 116. The at least two raised features 240 are integral with the harness bracket 202 to define a one-piece, unitary part, therefore reducing the number of parts of the mounting assembly 200. The at least two raised features 240 define at least two direct contact areas for the fastener 114 so that when the tooth washer 118 is pressed fitted onto the fastener 114 a touch condition (via the fastener 114) can be maintained between the anchor plate 110 and the harness bracket 202 with no tilting of the harness bracket and the fastener 114 is to freely rotate. In the depicted aspect, the at least two raised features 240 on the harness bracket 202 include at least three raised features 240 extended from the upper surface. In FIG. 6, the at least three raised features 240 define a contact plane 250 for the fastener that is extended parallel to the upper surface 212 of the harness bracket 202. By defining the contact plane 250 arranged parallel to the upper surface 212, which is in contrast to the configuration of the split washer 116, the harness bracket 202 is prevented from tilting atop the anchor plate 110 by the contact of the fastener 114 with the at least three raised features 240. Therefore, with the tooth washer 118 fitted onto the fastener 114 and pressed immediately adjacent to or against the underside or lower surface 134 of the anchor plate 110, the position of the harness bracket 202 atop the anchor plate 110 is maintained during transportation and/or handling of the vehicle part 102. And this, in turn, allows for ease of later installation of the vehicle part 102.

According to the present disclosure, the at least three raised features 240 can be in the form of standoff protrusions or tabs extended from the upper surface 212 and located adjacent the through hole 220. As shown in FIG. 7, the at least three standoff protrusions or tabs 240 can be approximately equally, angularly spaced from one another relative to a center axis 252 defined by the through hole 220; although, this is not required. Further, where the fastener 114 is a bolt, the at least three standoff protrusions or tabs 240 are positioned to be inward of an outer edge of the bolt head 256 so as to approximately evenly distribute an applied load of the bolt on the harness bracket 202, similar to the split washer 116 but, again, without the problems associated with the split washer 116 and the known mounting assembly 100. As shown in FIGS. 6 and 7, each standoff protrusion or tab 240 is configured to have an edge surface 260 located above the upper surface 212 of the harness bracket body 210. By way of example, each standoff protrusion or tab 240 can be substantially triangular shaped with side surfaces 262, 264 converging to the edge surface 260. The edge surfaces 260 can be extended radially relative to the center axis 252 defined by the through hole 220. The edge surfaces 260 define the contact plane 250. As such, the edge surface 260 of each standoff protrusion or tab 240 is in direct contact with the fastener 114, thereby supporting the fastener 114 in at least three locations. This arrangement of the at least three raised features 240 allow for free rotation of the fastener atop the harness bracket 202 and prevents tilting of the fastener 114, which, in turn, can cause tilting of the harness bracket atop the anchor plate 110.

Further, each standoff protrusion or tab 240 can be configured to at least partially compress via an applied load of the fastener 114 on the harness bracket 202, which provides similar benefits of the split washer 116. To allow for this compression, the harness bracket 202 include at least three cutouts 270, one cutout for each standoff protrusion or tab 240. The cutouts 270 can extend from the through hole 220; although, this is not required. The cutouts 270 can also extend through the body 210; although, this is also not required. As shown, each standoff protrusion or tab 240 is cantilevered into one of the cutouts 270 such that the edge surface 260 of each standoff protrusion or tab 240 is positioned over the respective cutout 270 in the height direction. This positioning allows the standoff protrusion or tab 240 to at least partially move or compress into the cutout 270. The at least partial movement or compression of each standoff protrusion or tab 240 via an applied load of the fastener 114 is similar to the compression of the split washer 116. Therefore, the exemplary harness bracket 202 can protect against vibrations and distribute an applied load of the fastener 114 more evenly to the harness bracket 202 to prevent tilting of the harness bracket relative to the anchor plate 110.

Therefore, the present disclosure teaches the exemplary harness bracket 202 for the mounting assembly 200 for transportation or handling of the vehicle part 102. The harness bracket 202 includes the at least three standoff protrusions or tabs 240 that function substantially the same as the split washer 116 of the known mounting assembly 100, which eliminates the need for the split washer. Also, the at least three standoff protrusions or tabs 240 prevent the harness bracket 202 from tilting atop the anchor plate 110. If there is no tilting, then the position of the tooth washer 118 can be controlled so that the setting of the tooth washer 118 on the underside of lower surface 134 of the anchor plate 110 allows the fastener 114 to freely rotate but the at least one alignment tab 228 of the harness bracket 202 does not loose contact with outer peripheral edge portion 166 of the anchor plate 110. By remining in contact with the anchor plate 110, the clock position of the harness bracket 202 remains in design position during transportation and/or handling of the vehicle part 102.

As is evident from the foregoing, the present disclosure further discloses a method of assembling a mounting arrangement (i.e., the mounting assembly 200) for transportation and/or handling of an associated vehicle part 102. The method comprises providing an anchor plate 110 for connection to the associated vehicle part, the anchor plate 110 including a mounting aperture 144; providing a harness bracket 202 including a through hole 220, and positioning the harness bracket 202 atop the anchor plate 110 relative to a height direction of the mounting arrangement 200 with the through hole 220 aligned with the mounting aperture 144, wherein the harness bracket 202 further includes at least three standoff projections 240 extended from an upper surface 212 of the harness bracket 202 and located adjacent the through hole 220; providing a fastener 114, and extending the fastener 114 through the through hole 220 and the mounting aperture 144, wherein the fastener 114 is in direct contact with the at least three standoff projections 240; and providing a tooth washer 118, and press fitting the tooth washer 118 onto the fastener 114 extended beneath the anchor plate 110 to maintain positioning of the harness bracket 202 atop the anchor plate 110.

The exemplary method further includes defining a contact plane 250 by the at least three standoff projections 240 for the fastener 114 that is extended parallel to the upper surface 212 of the harness bracket 202 to prevent tilting of the harness bracket 202 atop the anchor plate 110 by the contact of fastener 114 with the at least three standoff projections 240. The exemplary method further includes configuring each standoff protrusion 240 to at least partially compress via an applied load of the fastener on the harness bracket 202. The exemplary method further includes providing at least three cutouts 270 in the harness bracket 202 and cantilevering each standoff protrusion 240 into one of the cutouts 270 allowing the standoff protrusion 240 to at least partially compress or move into the cutout 270.

It will be appreciated that the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A mounting assembly for transportation and/or handling of an associated vehicle part, the mounting assembly comprising:
an anchor plate including a mounting aperture;
a harness bracket positioned atop the anchor plate relative to a height direction of the mounting assembly, the harness bracket includes a through hole aligned with the mounting aperture and at least two raised features extended from an upper surface of the harness bracket and located adjacent the through hole, the at least two raised features integral with the harness bracket;
a fastener extended through the through hole and the mounting aperture, the fastener in direct contact with the at least two raised features; and
a tooth washer press fitted onto the fastener beneath the anchor plate to maintain positioning of the harness bracket atop the anchor plate.

2. The mounting assembly of claim 1, wherein the harness bracket includes at least one alignment tab, and in an installed position of the harness bracket atop the anchor plate where the at least one alignment tab is engaged to an outer edge portion of the anchor plate, the tooth washer is adapted to maintain the installed position of the harness bracket atop the anchor plate.

3. The mounting assembly of claim 1, wherein the harness bracket includes at least three raised features extended from the upper surface.

4. The mounting assembly of claim 3, wherein the at least three raised features define a contact plane for the fastener that is extended parallel to the upper surface thereby preventing tilting of the harness bracket atop the anchor plate by contact of the fastener with the at least three raised features.

5. The mounting assembly of claim 3, where the fastener is a bolt, the at least three raised features are positioned to be inward of an outer edge of a bolt head so as to approximately evenly distribute an applied load of the bolt on the harness bracket.

6. The mounting assembly of claim 3, wherein each raised feature is defined by a tab configured to have an edge surface located above the upper surface, the edge surface of each tab is in direct contact with the fastener.

7. The mounting assembly of claim 6, wherein each tab is configured to at least partially compress via an applied load of the fastener on the harness bracket.

8. The mounting assembly of claim 7, wherein the harness bracket includes at least three cutouts, each tab cantilevered into one of the cutouts allowing the edge surface of each tab to at least partially compress.

9. The mounting assembly of claim 3, wherein the at least three raised features are adapted to allow for free rotation of the fastener atop the at least three raised features.

10. A harness bracket for a mounting assembly for transportation and/or handling of a vehicle part, the mounting assembly includes an anchor plate secured to the vehicle part, the harness bracket positioned atop the anchor plate, a fastener positioned atop the harness bracket and extended through the anchor plate and the harness bracket, and a tooth washer fitted onto the fastener beneath the anchor plate, the harness bracket comprising:
a through hole for receipt of the fastener, and at least three standoff protrusions integrally formed on an upper surface of the harness bracket and located about the through hole for spacing the fastener from the upper surface.

11. The harness bracket of claim 10, wherein the at least three standoff protrusions define a contact plane for the fastener that is extended parallel to the upper surface.

12. The harness bracket of claim 10, wherein each standoff protrusion includes an edge surface located above the upper surface, the edge surface of each standoff protrusion is adapted for direct contact with the fastener.

13. The harness bracket of claim 10, wherein each standoff protrusion is configured to at least partially compress via an applied load of the fastener on the harness bracket.

14. The mounting assembly of claim 13, wherein the harness bracket includes at least three cutouts, each standoff protrusion cantilevered into one of the cutouts allowing the standoff protrusion to at least partially compress into the cutout.

15. A method of assembling a mounting arrangement for transportation and/or handling of an associated vehicle part, the method comprising:
providing an anchor plate for connection to the associated vehicle part, the anchor plate including a mounting aperture;
providing a harness bracket including a through hole, and positioning the harness bracket atop the anchor plate relative to a height direction of the mounting arrangement with the through hole aligned with the mounting aperture, wherein the harness bracket further includes at least three standoff projections extended from an upper surface of the harness bracket and located adjacent the through hole;
providing a fastener, and extending the fastener through the through hole and the mounting aperture, wherein the fastener is in direct contact with the at least three standoff projections; and
providing a tooth washer, and press fitting the tooth washer onto the fastener extended beneath the anchor plate to maintain positioning of the harness bracket atop the anchor plate.

16. The method of claim 15, including defining a contact plane by the at least three standoff projections for the fastener that is extended parallel to the upper surface to prevent tilting of the harness bracket atop the anchor plate by contact of fastener with the at least three standoff projections.

17. The method of claim 15, including configuring each standoff protrusion to at least partially compress via an applied load of the fastener on the harness bracket.

18. The method of claim 17, including providing at least three cutouts in the harness bracket and cantilevering each standoff protrusion into one of the cutouts allowing the standoff protrusion to at least partially compress or move into the cutout.
